(19) United States
(12) Patent Application Publication
(10) Pub. No.: US 2026/0213053 A1
(43) Pub. Date: Jul. 23, 2026

(54) Organic Film-Coated Soft Magnetic Powder, Method For Producing Organic Film-Coated Soft Magnetic Powder, Dust Core, Magnetic Element, And Electronic Device

(71) Applicant: SEIKO EPSON CORPORATION, Tokyo (JP)

(72) Inventors: Momoko WAKABAYASHI, Hachinohe (JP); Keisuke AIDA, Hachinohe (JP)

(21) Appl. No.: 19/454,902

(22) Filed: Jan. 21, 2026

(30) Foreign Application Priority Data
Jan. 22, 2025 (JP) 2025-009114

(51) Int. Cl. H01F 1/26; B22F 1/052; B22F 1/105; B22F 1/16; H01F 3/08

(52) U.S. Cl. CPC H01F 1/26; B22F 1/052; B22F 1/105; B22F 1/16; H01F 3/08; B22F 2302/25; B22F 2998/10

(57) ABSTRACT

An organic film-coated soft magnetic powder includes: an oxide film-coated soft magnetic powder including a soft magnetic powder and an oxide film containing an oxide of an element contained in a soft magnetic metal material; and an organic film containing a compound derived from a coupling agent having an amino group, a hydrolyzable group, and a linear alkyl group; wherein the average particle diameter on a volume basis is 1.0 μm or more and less than 10.0 μm or less; and when the minimum coating area [m²/g] of the coupling agent is CS and the specific surface area [m²/g] of the oxide film-coated soft magnetic powder is Sm, the actual addition amount [mass %] of the coupling agent is 0.5 times or more and less than 2.0 times or less of the theoretical addition amount CA [mass %] of the coupling agent calculated by the following formula. CA=Sm/CS×100

The present application is based on, and claims priority from JP Application Serial Number 2025-009114, filed Jan. 22, 2025, the disclosure of which is hereby incorporated by reference herein in its entirety.

### BACKGROUND

### 1. Technical Field

The present disclosure relates to an organic film-coated soft magnetic powder, a method for producing an organic film-coated soft magnetic powder, a dust core, a magnetic element, and an electronic device.

### 2. Related Art

JP-A-2024-140109 discloses an insulator-coated soft magnetic powder including a soft magnetic powder, an inorganic insulating film coating a particle surface of the soft magnetic powder and containing ceramics, and an organic film coating the surface of the inorganic insulating film and containing a compound derived from a coupling agent having a hydrophobic functional group.

JP-A-2024-140109 discloses that the soft magnetic powder has the average particle size of 1 μm or more and 20 μm or less and that a silane coupling agent having a NH₂ group, a spacer, and a hydrolyzable group is used.

According to such a configuration, it is possible to achieve an insulator-coated soft magnetic powder having excellent moisture resistance and suppressing decreases in insulation properties and fluidity associated with moisture absorption.

JP-A-2024-140109 is an example of the related art.

In the insulator-coated soft magnetic powder described in JP-A-2024-140109, a method for forming an organic film using a silane coupling agent containing a NH₂ group is disclosed. However, the insulator-coated soft magnetic powder formed using the silane coupling agent has a problem that it is difficult to achieve both fillability and compatibility with a binder resin. In addition, there is a concern that the variation in strength of a green compact made from such an insulator-coated soft magnetic powder may increase.

### SUMMARY

An organic film-coated soft magnetic powder according to an application example of the present disclosure includes:
an oxide film-coated soft magnetic powder including a soft magnetic powder made of a soft magnetic metal material containing Fe, Si, and B, and an oxide film provided on the surface of the soft magnetic powder and containing an oxide of an element contained in the soft magnetic metal material; and
an organic film provided on the surface of the oxide film-coated soft magnetic powder and containing a compound derived from a coupling agent having an amino group, a hydrolyzable group, and a linear alkyl group located between the amino group and the hydrolyzable group;
wherein the average particle diameter on a volume basis measured by a laser diffraction particle size distribution measuring device is 1.0 μm or more and less than 10.0 μm; and
when the minimum coating area [m²/g] of the coupling agent is CS and the specific surface area [m²/g] of the oxide film-coated soft magnetic powder is Sm, the actual addition amount [mass %] of the coupling agent, calculated from the content [mass %] of the compound, is 0.5 times or more and less than 2.0 times of the theoretical addition amount CA [mass %] of the coupling agent calculated by the following formula.

$$CA = Sm / CS \times 100$$

A method for producing the organic film-coated soft magnetic powder according to an application example of the present disclosure includes:
causing a hydrolysis reaction and a condensation reaction of a coupling agent in the presence of an oxide film-coated soft magnetic powder, the oxide film-coated soft magnetic powder including a soft magnetic powder made of a soft magnetic metal material containing Fe, Si, and B and an oxide film provided on the surface of the soft magnetic powder and containing an oxide of an element contained in the soft magnetic metal material, and a coupling agent having an amino group, a hydrolyzable group, and a linear alkyl group located between the amino group and the hydrolyzable group, to form an organic film provided on the surface of the oxide film-coated soft magnetic powder, the organic film containing a compound derived from the coupling agent, thereby obtaining the organic film-coated soft magnetic powder;
wherein the average particle diameter on a volume basis measured by a laser diffraction particle size distribution measuring device is 1.0 μm or more and less than 10.0 μm; and
when the minimum coating area [m²/g] of the coupling agent is CS and the specific surface area [m²/g] of the oxide film-coated soft magnetic powder is Sm, the actual addition amount [mass %] of the coupling agent used in the steps is 0.5 times or more and less than 2.0 times of the theoretical addition amount CA [mass %] of the coupling agent calculated by the following formula.

$$CA = Sm / CS \times 100$$

A dust core according to an application example of the present disclosure includes:
the organic film-coated soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a cross-sectional view schematically showing one particle of an organic film-coated soft magnetic powder according to an embodiment.

FIG. 2 is a cross-sectional view schematically showing one particle of a modified example of the organic film-coated soft magnetic powder according to the embodiment.

FIG. 3 is a plan view schematically showing a toroidal type coil component.

FIG. 4 is a transparent perspective view schematically showing a closed magnetic circuit type coil component.

FIG. 5 is a perspective view showing a mobile personal computer which is an electronic device according to the embodiment.

FIG. 6 is a plan view showing a smartphone which is an electronic device according to the embodiment.

FIG. 7 is a perspective view showing a digital still camera which is an electronic device according to the embodiment.

FIG. 8 is Table 1 showing the compositions and the like of the organic film-coated soft magnetic powders of sample Nos. 1 to 13.

FIG. 9 is Table 2 showing the compositions and the like of the organic film-coated soft magnetic powders of sample Nos. 14 to 21.

FIG. 10 is Table 3 showing the evaluation results and the like of the organic film-coated soft magnetic powders of sample Nos. 1 to 13.

FIG. 11 is Table 4 showing the evaluation results and the like of the organic film-coated soft magnetic powders of sample Nos. 14 to 21.

### DESCRIPTION OF EMBODIMENTS

Hereinafter, an organic film-coated soft magnetic powder, a method for producing an organic film-coated soft magnetic powder, a dust core, a magnetic element, and an electronic device according to the present disclosure will be described in detail based on preferred embodiments shown in the accompanying drawings.

### 1. ORGANIC FILM-COATED SOFT MAGNETIC POWDER

First, an organic film-coated soft magnetic powder 1 according to an embodiment will be described.

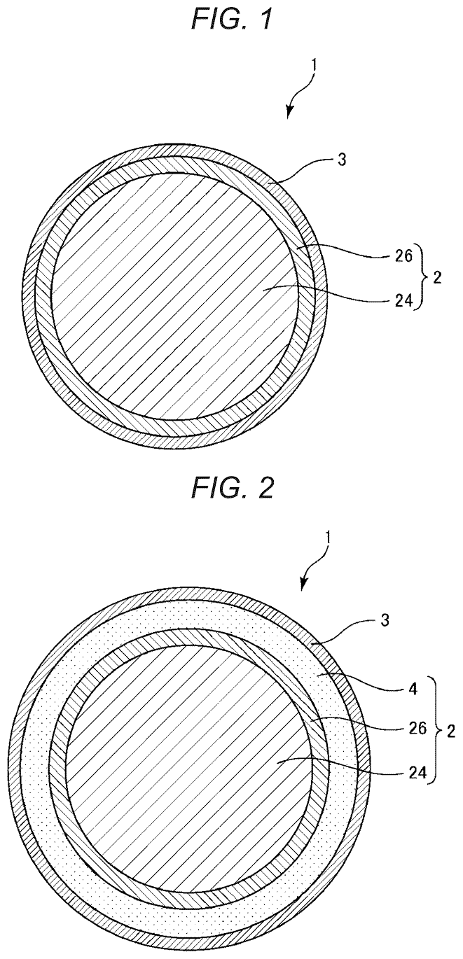

FIG. 1 is the cross-sectional view schematically showing one particle of the organic film-coated soft magnetic powder 1 according to the embodiment.

The organic film-coated soft magnetic powder 1 shown in FIG. 1 has an oxide film-coated soft magnetic powder 2 and an organic film 3 provided so as to coat the surface of the oxide film-coated soft magnetic powder 2. The coating described in the present disclosure is a concept including not only a state of covering the entire surface of the oxide film-coated soft magnetic powder 2 but also a state of covering a part of the surface.

The oxide film-coated soft magnetic powder 2 includes a soft magnetic powder 24 made of a soft magnetic metal material containing Fe, Si, and B, and an oxide film 26 provided on the surface of the soft magnetic powder 24. The oxide film 26 contains an oxide of an element contained in the above soft magnetic metal material.

The organic film 3 contains a compound derived from a coupling agent having an amino group, a hydrolyzable group, and a linear alkyl group located between the amino group and the hydrolyzable group.

In addition, the average particle diameter on a volume basis of the organic film-coated soft magnetic powder 1 measured by a laser diffraction particle size distribution measuring device is 1.0 μm or more and less than 10.0 μm.

Further, when the minimum coating area [m²/g] of the coupling agent is CS and the specific surface area [m²/g] of the oxide film-coated soft magnetic powder 2 is Sm, the actual addition amount [mass %] of the coupling agent, calculated from the content [mass %] of the compound described above, is 0.5 times or more and less than 2.0 times of the theoretical addition amount CA [mass %] of the coupling agent calculated by the following formula.

$$CA = Sm / CS \times 100$$

According to such a configuration, the organic film-coated soft magnetic powder 1 capable of producing a green compact with excellent fillability, compatibility with a binder resin, and little variation in strength is obtained. Therefore, by using the organic film-coated soft magnetic powder 1, a green compact having a high density and stable mechanical strength is obtained.

### 1.1. Oxide Film-Coated Soft Magnetic Powder

The oxide film-coated soft magnetic powder 2 shown in FIG. 1 has the soft magnetic powder 24 and the oxide film 26.

### 1.1.1. Composition of Soft Magnetic Metal Material

The soft magnetic powder 24 is made of a soft magnetic metal material containing Fe, Si, and B.

Examples of the metal structure formed of the soft magnetic metal material include a crystal structure, a non-crystalline (amorphous) structure, a microcrystalline (nanocrystalline) structure, and the like. Among these, the soft magnetic metal material preferably contains an amorphous alloy having the amorphous structure or a nanocrystalline alloy having the nanocrystalline structure. By containing these, the coercive force is reduced, and hysteresis loss of the magnetic element is reduced. In the soft magnetic metal material, structures having different crystallinity may be mixed.

Examples of the amorphous alloy material and the nanocrystalline alloy material include an Fe—Si—B-based alloy material, an Fe—Si—B—C-based alloy material, an Fe—Si—B—Cr—C-based alloy material, a Fe—Co—Si—B-based alloy material, an Fe—Si—B—Nb-based alloy material, an Fe—Si—B—Nb—Cu-based alloy material, and the like.

The soft magnetic metal material is particularly preferably an amorphous alloy material made of a composition represented by the following composition formula and impurities. Accordingly, the oxide film-coated soft magnetic powder 2 having both high permeability and low coercive force is obtained.

A composition formula represented in atomic ratios: (Fe_{1-X}Cr_{X})ₐ(Si_{1-Y}B_{Y})_{b}C_{c}
[wherein b=100-a-c, and 70.0≤a≤82.0, 0≤c≤4.0, 0≤x≤0.060, and 0.30≤y≤0.90].

The composition formula represents a ratio in terms of the number of atoms in a composition containing five elements of Fe, Cr, Si, B, and C. In the above composition formula, the essential elements are Fe, Si, and B.

Fe (iron) greatly affects basic magnetic properties and mechanical properties of the oxide film-coated soft magnetic powder 2.

A content of Fe is not particularly limited, and is set such that Fe is a main component, that is, the ratio in terms of the number of atoms is the highest in the oxide film-coated soft magnetic powder 2. In the oxide film-coated soft magnetic powder 2, the content of Fe is preferably 72.0 atomic % or more and 82.0 atomic % or less, more preferably 72.5 atomic % or more and 81.5 atomic % or less, and still more preferably 73.0 atomic % or more and 81.0 atomic % or less.

Cr (chromium) acts to improve the corrosion resistance of the oxide film-coated soft magnetic powder 2. By improving the corrosion resistance, oxidation is inhibited, and deterioration in the magnetic properties associated with the oxidation can be inhibited. A passive film also enhances the insulation properties and contributes to preventing eddy current loss in the oxide film-coated soft magnetic powder 2.
x represents a ratio of a content of Cr to a total content when a total of the content of Fe and the content of Cr is 1. In the oxide film-coated soft magnetic powder 2, 0≤x≤0.060 is preferable, 0.010≤x≤0.050 is more preferable, and 0.020≤x≤0.040 is further preferable.
a represents a ratio of a total content of Fe and Cr to a total content when the total mass of the five elements is 100. In the oxide film-coated soft magnetic powder 2, 70.0≤a≤82.0 is preferable, 72.0≤a≤81.0 is more preferable, and 73.0≤a≤80.5 is further preferable.

When the oxide film-coated soft magnetic powder 2 is produced from a raw material, Si (silicon) promotes amorphization and enhances the permeability of the oxide film-coated soft magnetic powder 2. Accordingly, high permeability and low coercive force can be achieved.

B (boron) promotes amorphization when producing the oxide film-coated soft magnetic powder 2 from a raw material. In particular, by using Si and B in combination, the amorphization can be synergistically promoted based on a difference in an atomic radius between Si and B. Accordingly, high permeability and low coercive force can be sufficiently achieved.

y represents a ratio of a content of B to a total content when a total of the content of Si and the content of B is 1. In the oxide film-coated soft magnetic powder 2, 0.30≤y≤0.90 is preferable, and 0.40≤y≤0.80 is more preferable.

Carbon (C) lowers the viscosity of a molten material when the raw material for the oxide film-coated soft magnetic powder 2 is melted, facilitating amorphization and pulverization. Accordingly, the oxide film-coated soft magnetic powder 2 having a small diameter and high permeability can be obtained. As a result, eddy current loss can be reduced even in a high frequency range.

c represents the content of C when the total mass of the five elements is 100. In the oxide film-coated soft magnetic powder 2, 0≤c≤4.0 is preferable, 1.0≤c≤2.8 is more preferable, and 1.5≤c≤2.5 is further preferable.

The composition of the soft magnetic metal material is identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge atomic emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur(S), an infrared absorption method after combustion in a current of oxygen (combustion in high frequency induction furnace) defined in JIS G 1211:2011 is also used. Specifically, an example thereof is a carbon and sulfur analyzer CS-200 manufactured by LECO Corporation.

When nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

### 1.1.2. Oxide Film

The oxide film 26 contains an oxide of an element contained in the above soft magnetic metal material. Since the soft magnetic metal material contains Fe, Si, and B, the oxide film 26 contains at least one of iron oxide, silicon oxide, and boron oxide.

In addition to the above oxides, the oxide film 26 may include chromium oxide, nickel oxide, cobalt oxide, manganese oxide, phosphorus oxide, aluminum oxide, magnesium oxide, calcium oxide, zinc oxide, titanium oxide, vanadium oxide, cerium oxide, or the like. In addition, the oxide film 26 may include two or more types thereof.

These oxides suppress the progress of oxidation of the soft magnetic powder 24 and contribute to suppression of a decrease in magnetic properties. These oxides have a high-density hydroxyl group on the surface. This contributes to improvement in adhesion of the organic film 3 described later.

The average thickness of the oxide film 26 is preferably 0.5 nm or more and 50 nm or less, and more preferably 1 nm or more and 10 nm or less. Accordingly, the corrosion resistance of the oxide film-coated soft magnetic powder 2 and the adhesion of the organic film 3 can be further enhanced.

The average thickness of the oxide film 26 is measured, for example, by magnifying and observing a cross section of the organic film-coated soft magnetic powder 1. Specifically, one particle of the organic film-coated soft magnetic powder 1 is cut to prepare a cross-sectional thin sample. Next, the obtained cross-sectional thin sample is observed with a scanning transmission electron microscope, and the thickness of the oxide film 26 is measured at five or more positions. Further, measured values are averaged, and a calculation result is taken as the average thickness of the oxide film 26. A distribution range of the oxide film 26 in an observation image can be confirmed more clearly by using, for example, energy dispersive X-ray analysis (EDX analysis), Auger electron spectroscopy, or the like in combination.

The oxide film-coated soft magnetic powder 2 may be a powder produced by any method. Examples of the production method include various atomization methods such as a water atomization method, a gas atomization method, and a rotary water flow atomization method, as well as a reduction method, a carbonyl process, and a pulverization method. Among these, the atomization method is preferably used. In addition, in the water atomization method and the rotary water flow atomization method, since powdering is performed by contact between the molten metal and water, the oxide film 26 having an appropriate thickness is easily formed at the surface of the oxide film-coated soft magnetic powder 2. Furthermore, in the rotary water atomization method, the oxide film-coated soft magnetic powder 2 having a particle diameter described later can be efficiently produced.

The thickness of the oxide film 26 is adjusted by the production conditions of the oxide film-coated soft magnetic powder 2, for example, the cooling rate of the molten metal and the like. Specifically, when the cooling rate is decreased, the oxide film 26 tends to be thick.

The oxide film 26 preferably covers the entire surface of the soft magnetic powder 24, but there may be a discontinuous portion.

### 1.2. Organic Film

The organic film 3 is formed by reacting a coupling agent having an amino group, a hydrolyzable group, and a linear alkyl group with the surface of the oxide film-coated soft magnetic powder 2. Therefore, the organic film 3 includes a compound derived from the coupling agent, that is, a compound having a structure obtained by a condensation reaction between the hydrolysate of the hydrolyzable group and the oxide film-coated soft magnetic powder 2, and a compound having an amino group and a linear alkyl group. Accordingly, fillability and good compatibility with a binder resin are imparted to the organic film-coated soft magnetic powder 1. In addition, hygroscopicity of the organic film-coated soft magnetic powder 1 is suppressed, and a decrease in fillability of the organic film-coated soft magnetic powder 1 associated with aggregation is suppressed.

The coupling agent is, for example, a compound represented by the following general Formula (I).

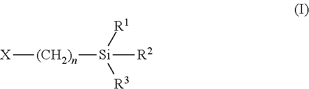

In above general Formula (I), each of R¹, R² and R³ independently represents a hydrogen atom, an alkoxy group, a halogen atom, or an alkyl group. However, at least one, preferably two or three, of R¹, R² and R³ is an alkoxy group or a halogen atom which is a hydrolyzable group. R¹, R² and R³ may be the same as or different from each other.

In the above general formula (I), —(CH₂)ₙ— represents a linear alkyl group. n is preferably an integer of 1 or more and 20 or less and more preferably an integer of 1 or more and 12 or less.

In the above general formula (I), X is a functional group containing an amino group. The functional group X may contain two or more amino groups, but from the viewpoint of compatibility with a binder resin, an amino group is preferably present at the terminal.

When the hydrolyzable group is, for example, an alkoxy group, hydrolysis reaction and a condensation reaction occur in the alkoxy group to produce a compound derived from the coupling agent. This compound forms the organic film 3 bonded to the oxide film-coated soft magnetic powder 2.

The linear alkyl group imparts moisture resistance and lipophilicity to the above compound that forms the organic film 3. Accordingly, aggregation associated with moisture absorption of the organic film-coated soft magnetic powder 1 can be suppressed, and a decrease in fillability can be suppressed. In addition, the affinity of the organic film 3 with a binder resin can be enhanced. That is, in the organic film 3, both the amino group and the linear alkyl group contribute to the compatibility with a binder resin.

The number (n described above) of carbon atoms in the linear alkyl group is more preferably an integer of 1 or more and 6 or less, and particularly preferably an integer of 3 or more and 6 or less. When the number of carbon atoms in the linear alkyl group falls within the above range, the compounds are easily aligned in the organic film 3 due to the interaction between the linear alkyl groups. This makes it easier to arrange amino groups on the surface. In addition, it is possible to sufficiently ensure the above moisture resistance and lipophilicity while preventing the occupancy rate of the organic film 3 from increasing more than necessary.

Examples of the amino group include a primary amino group and a secondary amino group. Among these, the amino group of the coupling agent is preferably a primary amino group. The primary amino group has excellent reactivity with, for example, an epoxy group and the like, and thus can particularly contribute to compatibility with a binder resin.

The average thickness of the organic film 3 is determined according to the molecular weight and the like of the above compound, and is, for example, preferably 1 nm or more and 100 nm or less, and more preferably 3 nm or more and 30 nm or less. Accordingly, the organic film 3 forms a monomolecular film or a molecular film close thereto. Therefore, the above effect of the organic film 3 can be obtained, while suppressing the deterioration of the magnetic properties of the organic film-coated soft magnetic powder 1 associated with an excessive thickness of the organic film 3.

The average thickness of the organic film 3 can be specified by, for example, a qualitative and quantitative analysis in a depth direction using X-ray photoelectron spectroscopy and ion sputtering in combination. Specifically, a concentration of the component derived from the coupling agent is examined along the depth direction. A region where the concentration of the component derived from the coupling agent is high is defined as the average thickness of the organic film 3. Specifically, when the concentration is changed in the vicinity of the boundary between the organic film 3 and the oxide film-coated soft magnetic powder 2, a position corresponding to half of an amount of change in the concentration, that is, a midpoint between the concentration on the organic film 3 side and the concentration on the oxide film-coated soft magnetic powder 2 side is regarded as the boundary, and the thickness from the boundary to a surface side may be set as the average thickness of the organic film 3.

### 1.3. Particle Diameter

In the volume-based cumulative particle size distribution of the organic film-coated soft magnetic powder 1 obtained using the laser diffraction particle size distribution measuring device, D50 is a particle diameter at which the cumulative frequency is 50% from the small diameter side.

The particle diameter D50 of the organic film-coated soft magnetic powder 1 is 1.0 μm or more and less than 10.0 μm, and preferably 3.0 μm or more and 8.0 μm or less. Since the organic film-coated soft magnetic powder 1 has a relatively small particle diameter, interparticle friction is suppressed, reducing the distance between particles and achieving good fillability. Accordingly, it is possible to further increase the density of the dust core. In addition, when the particle diameter D50 of the organic film-coated soft magnetic powder 1 is within the above range, it can contribute to suppression of eddy current loss of the magnetic element.

When the particle diameter D50 is less than the above lower limit value, the particle diameter becomes too small, and thus the production difficulty becomes high, aggregation occurs, and the fillability during powder compaction cannot be sufficiently enhanced. In addition, as the surface area increases, the amount of the binder resin necessary for binding the particles increases. In contrast, when the particle diameter D50 exceeds the above upper limit value, the distance between particles increases depending on the addition amount of the coupling agent, and the fillability during powder compaction cannot be sufficiently enhanced.

When the oxide film-coated soft magnetic powder 2 is produced by, for example, the atomization method, the particle diameter of the organic film-coated soft magnetic powder 1 can be adjusted by the supply rate of the molten metal, the pressure and flow rate of water as a cooling medium, and the like.

In addition, the particle diameter may be adjusted by a classification process of the produced powder. Examples of the classification process include dry classification such as sieving classification, inertial classification, centrifugal classification, and air classification, and wet classification such as sedimentation classification.

### 1.4. Addition Amount of Coupling Agent

The minimum coating area [m²/g] of the coupling agent is CS, and the specific surface area [m²/g] of the oxide film-coated soft magnetic powder 2 is Sm. At this time, the actual addition amount [mass %] of the coupling agent calculated from the content [mass %] of the compound derived from the coupling agent is 0.5 times or more and less than 2.0 times, preferably 0.7 times or more and 1.9 times or less, and more preferably 0.9 times or more and 1.8 times or less of the theoretical addition amount CA [mass %] of the coupling agent calculated by the following formula.

$$CA = Sm / CS \times 100$$

The actual addition amount [mass %] is calculated by dividing the mass of the organic film 3 by the mass of the organic film-coated soft magnetic powder 1. The mass of the organic film 3 can be calculated, for example, after observing the particle cross section of the organic film-coated soft magnetic powder 1 and calculating the areas of the organic film 3 and the organic film-coated soft magnetic powder 1, based on the known specific gravity of the organic film 3 and the known specific gravity of the oxide film-coated soft magnetic powder 2.

The minimum coating area [m²/g] of the coupling agent is calculated from the molecular model of Stuart-briegleb, and is calculated, for example, by the following formula.

$$Minimum coating area [ {m}^{2} / g ] = ( 78.3 \times 1000 ) / Molecular weight of coupling agent$$

The minimum coating area of the coupling agent may be obtained from an instruction manual, a catalog, or the like provided by the manufacturer of the coupling agent. In this case, the obtained value may be used instead of the calculated value.

The specific surface area [m²/g] of the oxide film-coated soft magnetic powder 2 is measured using a BET specific surface area measuring device HM1201-010 manufactured by MOUNTECH Co., Ltd., after the organic film 3 is removed from the organic film-coated soft magnetic powder 1. An amount of a sample is 5 g.

When the actual addition amount of the coupling agent is within the above range, since the amount of the compound derived from the coupling agent is optimized, it is possible to achieve the organic film-coated soft magnetic powder 1 capable of producing a green compact with excellent fillability and compatibility with a binder resin, and little variation in strength. Therefore, by using the organic film-coated soft magnetic powder 1, a green compact having a high density and stable mechanical strength is obtained.

When the actual addition amount of the coupling agent is less than the above lower limit value, the ratio of the amino group to the linear alkyl group decreases, resulting in reduced compatibility between the organic film-coated soft magnetic powder 1 and a binder resin, as well as increased interparticle friction of the organic film-coated soft magnetic powder 1, and the fillability decreases. In addition, since the occupancy rate of the organic film 3 is reduced, a region having high compatibility with a binder resin is reduced. Therefore, the variation in strength of the green compact produced using the organic film-coated soft magnetic powder 1 increases. In contrast, when the actual addition amount of the coupling agent exceeds the above upper limit value, the magnetic properties of the green compact produced using the organic film-coated soft magnetic powder 1 are deteriorated. In addition, the occupancy rate of the organic film 3 becomes excessive, and the amount of the compound that does not contribute to the improvement of the compatibility with a binder resin increases. As a result, the variation in strength of the green compact produced using the organic film-coated soft magnetic powder 1 increases.

The actual addition amount of the coupling agent is preferably 0.05 mass % or more and 0.30 mass % or less, more preferably 0.07 mass % or more and 0.25 mass % or less, and further preferably 0.09 mass % or more and 0.20 mass % or less. When the actual addition amount of the coupling agent is within the above range, the actual addition amount of the coupling agent can be further optimized, and thus the occurrence of shortage or excess of the coupling agent can be suppressed.

### 1.5. Various Properties

Next, various properties of the organic film-coated soft magnetic powder 1 will be described.

### 1.5.1. Moisture Content

The moisture content of the organic film-coated soft magnetic powder 1 is preferably 90 ppm or more and 1000 ppm or less, more preferably 150 ppm or more and 800 ppm or less, and further preferably 200 ppm or more and 600 ppm or less in terms of mass ratio. When the moisture content is within the above range, the organic film-coated soft magnetic powder 1 is less likely to absorb moisture and less likely to decrease in the fillability. In addition, since rust formation of the soft magnetic powder 24 due to moisture suppressed, a decrease in magnetic properties of the dust core can be suppressed.

When the moisture content is less than the above lower limit value, the fillability may greatly change associated with moisture absorption in a high-humidity environment. As a result, the variation in strength of the green compact may be large. In contrast, when the moisture content exceeds the above upper limit value, the moisture content is excessive, and thus the fillability of the organic film-coated soft magnetic powder 1 decreases, and the soft magnetic powder 24 may easily undergo rust formation.

The moisture content of the organic film-coated soft magnetic powder 1 is measured as follows.

First, the organic film-coated soft magnetic powder 1 is left for 24 hours in an environment of atmospheric pressure, a temperature of 30° C., and a relative humidity of 80%. Next, the organic film-coated soft magnetic powder 1 is heated to 250° C., and the moisture content in this state is measured by the Karl Fischer method. For the measurement of the moisture content by the Karl Fischer method, for example, a moisture measuring device CA-310 manufactured by NittoSeiko Analytech Co., Ltd. is used.

### 1.5.2. Oxygen Content

The oxygen content of the organic film-coated soft magnetic powder 1 is preferably 200 ppm or more and 5000 ppm or less, more preferably 250 ppm or more and 3000 ppm or less, and further preferably 300 ppm or more and 2500 ppm or less in terms of mass ratio. When the oxygen content of the organic film-coated soft magnetic powder 1 is within the above range, the adhesion between the organic film 3 and the oxide film-coated soft magnetic powder 2 can be particularly enhanced.

When the oxygen content is less than the above lower limit value, the content of the hydroxyl group reacting with the coupling agent decreases, and the adhesion between the organic film 3 and the oxide film-coated soft magnetic powder 2 may decrease. In contrast, when the oxygen content exceeds the above upper limit value, the magnetic properties of the organic film-coated soft magnetic powder 1 may deteriorate.

The oxygen content of the organic film-coated soft magnetic powder 1 is measured according to the general rule of oxygen quantification method of a metal material specified in JIS Z 2613:2006. Specifically, measurement can be performed using an oxygen and nitrogen analyzer TC-300/EF-300 manufactured by LECO Corporation, an oxygen, nitrogen, and hydrogen analyzer ONH836 manufactured by LECO Corporation, or the like.

### 1.5.3. Radial Crushing Strength

When a molded body is obtained using the organic film-coated soft magnetic powder 1 and an epoxy resin (binder resin), a radial crushing strength of the obtained molded body is preferably 23 MPa or more, more preferably 25 MPa or more and 45 MPa or less, and further preferably 27 MPa or more and 40 MPa or less. When the radial crushing strength of the molded body is within the above range, it is possible to achieve the organic film-coated soft magnetic powder 1 capable of producing a dust core having a mechanical strength within a practical range and little variation in strength.

When the radial crushing strength of the molded body is less than the above lower limit value, when a strong impact is applied to the dust core produced using the organic film-coated soft magnetic powder 1, chipping, cracking, or the like may occur in the dust core. In contrast, the radial crushing strength of the molded body may exceed the above upper limit value, but in this case, there is a concern that the variation in strength of the dust core increases or the dimensional accuracy decreases.

The radial crushing strength of the molded body is measured as follows.

First, an epoxy resin corresponding to 2.0 mass % of the organic film-coated soft magnetic powder 1 and the organic film-coated soft magnetic powder 1 are mixed and compressed at a pressure of 98.1 MPa (1.0 t/cm²) to be molded. Next, the obtained molded body is subjected to a heat treatment at 600° C. for 1 hour in an air atmosphere. Accordingly, an annular molded body having an outer diameter of 14 mm, an inner diameter of 8 mm, and a thickness of 3 mm is obtained. Next, the radial crushing strength of the obtained molded body is measured. A method for measuring the radial crushing strength is a method according to a radial crushing strength test method defined in JIS Z 2507:2000. Specifically, when the radial crushing strength is K, the outer diameter is D, a radial wall thickness (half a difference between the outer diameter and the inner diameter) is t, the thickness is L, and a breaking load is F, the radial crushing strength K is calculated by K=F (D−t)/(Lt²).

### 2. METHOD FOR PRODUCING ORGANIC FILM-COATED SOFT MAGNETIC POWDER

Next, a method for producing the organic film-coated soft magnetic powder according to the embodiment will be described.

The method for producing the organic film-coated soft magnetic powder according to the embodiment includes a step of causing a hydrolysis reaction and a condensation reaction in the presence of the oxide film-coated soft magnetic powder 2 and the coupling agent to form the organic film 3, thereby obtaining the organic film-coated soft magnetic powder 1.

As described above, the oxide film-coated soft magnetic powder 2 includes the soft magnetic powder 24 and the oxide film 26. The coupling agent has an amino group, a hydrolyzable group, and a linear alkyl group.

In addition, the organic film-coated soft magnetic powder 1 to be produced has an average particle diameter of 1.0 μm or more and less than 10.0 μm on a volume basis measured by a laser diffraction particle size distribution measuring device.

Further, when the minimum coating area [m²/g] of the coupling agent is CS and the specific surface area [m²/g] of the oxide film-coated soft magnetic powder 2 is Sm, the actual addition amount [mass %] of the coupling agent used in the above step is 0.5 times or more and less than 2.0 times, preferably 0.7 times or more and 1.9 times or less, and more preferably 0.9 times or more and 1.8 times or less of the theoretical addition amount CA [mass %] of the coupling agent calculated by the following formula.

$$CA = Sm / CS \times 100$$

When the actual addition amount of the coupling agent is within the above range, the organic film-coated soft magnetic powder 1 capable of producing a green compact with excellent fillability and compatibility with a binder resin, and little variation in strength can be produced. By using such organic film-coated soft magnetic powder 1, a green compact having a high density and stable mechanical strength can be obtained.

The moisture content of the produced organic film-coated soft magnetic powder 1 is preferably 50% or more and 120% or less, and more preferably 60% or more and 100% or less, of the moisture content of the oxide film-coated soft magnetic powder 2. When the moisture content of the organic film-coated soft magnetic powder 1 is within the above range, moisture absorption associated with the formation of the organic film 3 can be minimized. Therefore, it is possible to achieve the organic film-coated soft magnetic powder 1 in which defects such as rust formation over time, aggregation associated with moisture absorption, and the like are unlikely to occur.

The moisture content of the organic film-coated soft magnetic powder 1 may be less than the above lower limit value, but in this case, moisture may be easily absorbed over time. In contrast, when the moisture content of the organic film-coated soft magnetic powder 1 exceeds the above upper limit value, rust formation over time, aggregation, and the like may easily occur.

The moisture content of the oxide film-coated soft magnetic powder 2 is measured as follows.

First, the oxide film-coated soft magnetic powder 2 is left for 24 hours in an environment of atmospheric pressure, a temperature of 30° C., and a relative humidity of 80%. Next, the oxide film-coated soft magnetic powder 2 is heated to 250° C., and the moisture content in this state is measured by the Karl Fischer method. For the measurement of the moisture content by the Karl Fischer method, for example, a moisture measuring device CA-310 manufactured by NittoSeiko Analytech Co., Ltd. is used.

The specific surface area of the produced organic film-coated soft magnetic powder 1 is preferably 40% or more and 120% or less, and more preferably 50% or more and 100% or less of the specific surface area of the oxide film-coated soft magnetic powder 2. When the specific surface area of the organic film-coated soft magnetic powder 1 is within the above range, the change in the specific surface area associated with the formation of the organic film 3 can be minimized.

The specific surface area of the organic film-coated soft magnetic powder 1 may be less than the above lower limit value, but in this case, the film thickness of the organic film 3 may be increased in order to achieve the specific surface area. In contrast, when the specific surface area of the organic film-coated soft magnetic powder 1 exceeds the above upper limit value, the hygroscopicity increases, and the amount of a binder resin used may increase.

The specific surface area [m²/g] of the organic film-coated soft magnetic powder 1 is measured using a BET specific surface area measuring device HM1201-010 manufactured by MOUNTECH Co., Ltd. An amount of a sample is 5 g.

The oxygen content of the produced organic film-coated soft magnetic powder 1 is preferably 50% or more and 140% or less, and more preferably 80% or more and 120% or less, of the oxygen content of the oxide film-coated soft magnetic powder 2. When the oxygen content of the organic film-coated soft magnetic powder 1 is within the above range, the variation amount with respect to the oxygen content of the oxide film-coated soft magnetic powder 2 is suppressed. Therefore, it is possible to produce the organic film-coated soft magnetic powder 1 in which a decrease in magnetic properties associated with the formation of the organic film 3 is suppressed.

The oxygen content of the organic film-coated soft magnetic powder 1 may be less than the above lower limit value, but in this case, oxidation may easily proceed over time. Conversely, when the oxygen content of the organic film-coated soft magnetic powder 1 exceeds the above upper limit value, oxidation proceeds associated with the formation of the organic film 3, and the magnetic properties of the organic film-coated soft magnetic powder 1 may deteriorate.

The oxygen content of the oxide film-coated soft magnetic powder 2 is measured according to the general rule of the oxygen determination method for metal materials specified in JIS Z 2613:2006. Specifically, measurement can be performed using an oxygen and nitrogen analyzer TC-300/EF-300 manufactured by LECO Corporation, an oxygen, nitrogen, and hydrogen analyzer ONH836 manufactured by LECO Corporation, or the like.

### 3. MODIFICATIONS

Next, a modified example of the organic film-coated soft magnetic powder according to the embodiment will be described.

FIG. 2 is a cross-sectional view schematically showing one particle of a modified example of the organic film-coated soft magnetic powder 1 according to the embodiment.

The modified example will hereinafter be described focusing attention on differences from the embodiment described above, and the description of substantially the same matters will be omitted.

In the organic film-coated soft magnetic powder 1 shown in FIG. 2, the oxide film-coated soft magnetic powder 2 further includes an insulating coating 4 provided on the surface of the oxide film 26.

The insulating coating 4 includes ceramics or glass. Accordingly, sufficient electrical insulation properties are imparted to the insulating coating 4. As a result, the iron loss caused by the eddy current between the particles can be suppressed in the green compact. Further, when the terminal is formed at the green compact, the withstand voltage between the terminals can be enhanced.

Examples of the ceramics include oxides, nitrides, carbides, sulfides, borides, and the like, and one or a mixture of two or more thereof is used. Among these, oxides are preferably used. Oxides are often chemically stable and is useful as a constituent material of the insulating coating 4.

Examples of oxides include silicon oxides such as SiO₂, magnesium oxides such as MgO, calcium oxides such as Cao, aluminum oxides such as Al₂O₃, titanium oxides such as TiO₂, zirconium oxides such as ZrO₂, boron oxides such as B₂O₃, yttrium oxides such as Y₂O₃, phosphorus oxides such as P₂O₅, bismuth oxides such as Bi₂O₃, zinc oxides such as ZnO, tin oxides such as Sno, lead oxides such as PbO, lithium oxides such as Li₂O, sodium oxides such as Na₂O, potassium oxides such as K₂O, strontium oxides such as SrO, barium oxides such as gadolinium oxides such as Gd₂O₃, lanthanum oxides such as La₂O₃, and ytterbium oxides such as Yb₂O₃. These composition formulas are merely examples showing the composition ratios of each oxide, and each oxide may have composition ratios other than those described above. The insulating coating 4 may contain two or more of these oxides.

Examples of nitrides include silicon nitride such as Si₃N₄, aluminum nitride such as AlN, boron nitride such as BN, titanium nitride such as TiN, and tungsten nitride such as WN.

Examples of the glasses include soda glass, crystalline glass, quartz glass, lead glass, potassium glass, borosilicate glass, alkali-free glass, phosphate glass, and the like.

In addition, the insulating coating 4 may contain inorganic materials such as phosphates such as magnesium phosphate, calcium phosphate, zinc phosphate, manganese phosphate, or cadmium phosphate, and a silicate such as sodium silicate.

The average thickness of the insulating coating 4 is preferably 1 nm or more and 200 nm or less, more preferably 5 nm or more and 150 nm or less, and further preferably 10 nm or more and 100 nm or less. When the average thickness of the insulating coating 4 is within the above range, the insulation properties of the insulating coating 4 can be sufficiently ensured while the occupancy rate of the insulating coating 4 in the green compact can be reduced and the occupancy rate of the oxide film-coated soft magnetic powder 2 can be enhanced. In addition, even when the surface of the oxide film-coated soft magnetic powder 2 has unevenness, as long as the average thickness of the insulating coating 4 is within the above range, it also contributes to leveling and smoothing the unevenness and bringing the surface close to a spherical shape. Accordingly, the fillability of the organic film-coated soft magnetic powder 1 can be further enhanced.

When the average thickness of the insulating coating 4 is less than the above lower limit value, the insulation properties of the insulating coating 4 is insufficient, and the unevenness of the surface of the oxide film-coated soft magnetic powder 2 may not be sufficiently smoothed. In contrast, when the average thickness of the insulating coating 4 exceeds the above upper limit value, the insulating coating 4 may be easily peeled off, or the occupancy rate of the oxide film-coated soft magnetic powder 2 in the green compact may decrease.

The average thickness of the insulating coating 4 is measured, for example, by magnifying and observing a cross section of the organic film-coated soft magnetic powder 1. Specifically, one particle of the organic film-coated soft magnetic powder 1 is cut to prepare a cross-sectional thin sample. Next, the obtained cross-sectional thin sample is observed with a scanning transmission electron microscope, and the thickness of the insulating coating 4 is measured at five or more positions. Further, measured values are averaged, and a calculation result is taken as the average thickness of the insulating coating 4. A distribution range of the insulating coating 4 in an observation image can be confirmed more clearly by using, for example, energy dispersive X-ray analysis (EDX analysis), Auger electron spectroscopy, or the like in combination.

A method for forming the insulating coating 4 is not particularly limited, and examples thereof include a mechanochemical method, a gas phase film formation method, and a liquid phase film formation method. Examples of the gas phase film formation method include a plasma polymerization method, an atomic layer deposition (ALD) method, a chemical vapor deposition (CVD) method, and an ion plating method. Examples of the liquid phase film formation method include a sol-gel method and an electrolytic reduction method.

The mechanochemical method and the sol-gel method will be described below as representative methods.

### 3.1. Mechanochemical Method

The mechanochemical method is a method in which mechanical stress is applied to ceramic particles or glass particles to change physicochemical properties thereof. For example, by using a mechanochemical reaction device having a cylindrical chamber that rotates at a high speed and is provided with a compression tool and a blade inside, a mechanical interaction (mechanochemical reaction) is generated between the oxide film-coated soft magnetic powder 2 and ceramic particles or the like, thereby forming the insulating coating 4.

Examples of the mechanochemical reaction devices include a “Nobilta” (registered trademark) pulverizer and a “Mechanofusion” (registered trademark) pulverizer manufactured by Hosokawa Micron Corporation, and a “Hybridizer” (registered trademark) pulverizer manufactured by Nara Machinery.

### 3.2. Sol-Gel Method

The sol-gel method is a method for preparing an inorganic oxide by hydrolysis of a metal alkoxide. For example, when forming the insulating coating 4 from silicon oxide, a hydrolysis reaction of silicon alkoxide can be utilized. The method using silicon alkoxide will be described below.

First, the oxide film-coated soft magnetic powder 2 is dispersed in an alcohol solution containing silicon alkoxide. The alcohol solution includes lower alcohols such as ethanol and methanol. For example, 10 parts by mass or more and 50 parts by mass or less of alcohol may be mixed with 1 part by mass of silicon alkoxide.

Next, aqueous ammonia is mixed in as a catalyst to promote the reaction, causing hydrolysis. Accordingly, a dehydration condensation reaction occurs between the hydrolysates and between the hydrolysates and the silicon alkoxide to form-Si—O—Si-bonds on the particle surfaces. Accordingly, the insulating coating 4 made of silicon oxide is formed. Thereafter, the insulating coating 4 may be heated as necessary.

### 4. DUST CORE AND MAGNETIC ELEMENT

Next, the dust core and the magnetic element according to the embodiment will be described.

The magnetic element according to the embodiment can be applied to various magnetic elements including a magnetic core, such as a choke coil, an inductor, a noise filter, a reactor, a transformer, a motor, an actuator, a solenoid valve, and a generator. The dust core according to the embodiment can be applied to a magnetic core provided in these magnetic elements.

Hereinafter, two types of coil components will be representatively described as an example of the magnetic element.

### 4.1. Toroidal Type

First, a toroidal type coil component, which is the magnetic element according to the embodiment, will be described.

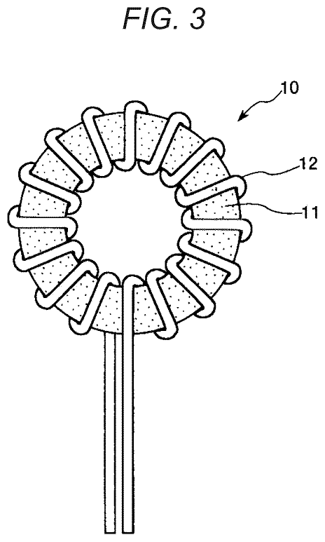

FIG. 3 is a plan view schematically showing the toroidal type coil component. A coil component 10 shown in FIG. 3 includes a ring-shaped dust core 11 and a conductive wire 12 wound around the dust core 11.

The dust core 11 is obtained by mixing the organic film-coated soft magnetic powder 1 described above and a binder, supplying the obtained mixture to a mold, and pressurizing and molding. That is, the dust core 11 is a green compact containing the organic film-coated soft magnetic powder 1 according to the embodiment. In the coil component 10 including such dust core 11, variation in strength of the dust core 11 is small, and the dust core 11 has a high density. Therefore, when the coil component 10 is mounted on an electronic device or the like, the electronic device can be reduced in size, increased in output, and increased in reliability.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating film is provided on the surface of the conductive wire 12 as necessary.

A shape of the dust core 11 is not limited to the ring shape shown in FIG. 3, and may be, for example, a shape in which a part of the ring is missing, or a shape in which a shape in a longitudinal direction is linear.

The dust core 11 may contain, as necessary, a soft magnetic powder other than the organic film-coated soft magnetic powder 1 according to the embodiment, or a non-magnetic powder.

### 3.2. Closed Magnetic Circuit Type

Next, a closed magnetic circuit type coil component, which is the magnetic element according to the embodiment, will be described.

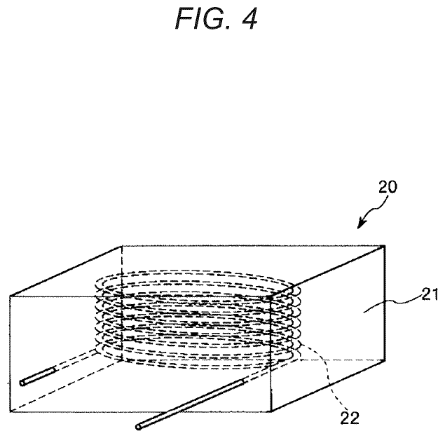

FIG. 4 is a transparent perspective view schematically showing the closed magnetic circuit type coil component.

Hereinafter, the closed magnetic circuit type coil component will be described. In the following description, differences from the toroidal type coil component will mainly be described, and description of similar matters will be omitted.

A coil component 20 shown in FIG. 4 includes a dust core 21 having a chip shape and a conductive wire 22 embedded in the dust core 21 and formed into a coil shape. That is, the dust core 21 is a green compact containing the organic film-coated soft magnetic powder 1 according to the embodiment. In the coil component 20 including such dust core 21, variation in strength of the dust core 21 is small, and the dust core 21 has a high density. Therefore, when the coil component 20 is mounted on an electronic device or the like, the electronic device can be reduced in size, increased in output, and increased in reliability.

The dust core 21 may contain, as necessary, a soft magnetic powder other than the organic film-coated soft magnetic powder 1 according to the embodiment, or a non-magnetic powder.

### 4. ELECTRONIC DEVICE

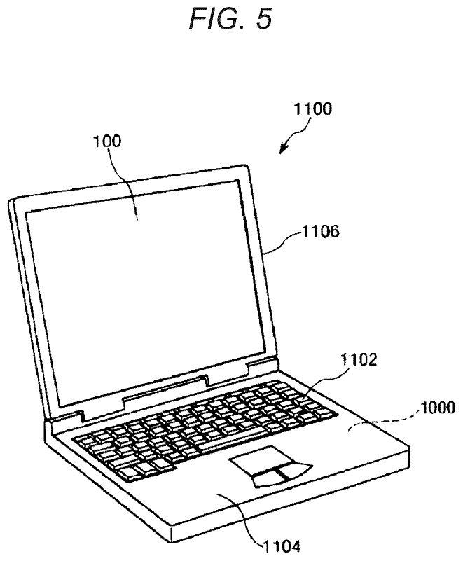

Next, an electronic device according to the embodiment will be described with reference to FIGS. 5 to 7.

FIG. 5 is a perspective view showing a mobile personal computer 1100 which is the electronic device according to the embodiment. The personal computer 1100 shown in FIG. 5 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

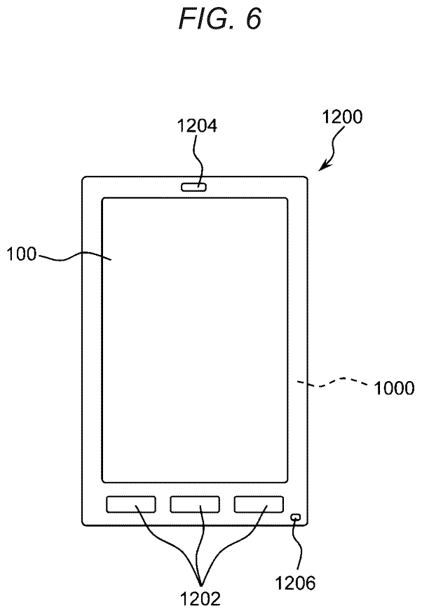

FIG. 6 is a plan view showing a smartphone 1200 which is the electronic device according to the embodiment. The smartphone 1200 shown in FIG. 6 includes a plurality of operation buttons 1202, an earpiece 1204, and a mouthpiece 1206. The display 100 is disposed between the operation buttons 1202 and the earpiece 1204. Such a smartphone 1200 includes therein the magnetic element 1000 such as an inductor, a noise filter, or a motor.

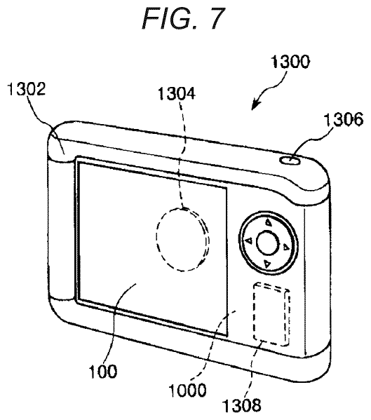

FIG. 7 is a perspective view showing a digital still camera 1300 which is the electronic device according to the embodiment. The digital still camera 1300 photoelectrically converts an optical image of a subject with an imaging element such as a charge coupled device (CCD) to generate an imaging signal.

The digital still camera 1300 shown in FIG. 7 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Such an electronic device includes the magnetic element according to the embodiment. Accordingly, it is possible to achieve the effects of the magnetic element, such as small variations in strength and high density of the dust core, thereby allowing the electronic device to be reduced in size, increased in output, and increased in reliability.

Examples of the electronic devices according to the embodiment include, in addition to the personal computer in FIG. 5, the smartphone in FIG. 6, and the digital still camera in FIG. 7, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

### 5. EFFECTS OF EMBODIMENT

As described above, the organic film-coated soft magnetic powder 1 according to the embodiment includes the oxide film-coated soft magnetic powder 2 and the organic film 3. The oxide film-coated soft magnetic powder 2 includes the soft magnetic powder 24 and the oxide film 26. The soft magnetic powder 24 is made of a soft magnetic metal material containing Fe, Si, and B. The oxide film 26 is provided on the surface of the soft magnetic powder 24 and contains an oxide of an element contained in the soft magnetic metal material. The organic film 3 is provided on the surface of the oxide film-coated soft magnetic powder 2 and contains a compound derived from a coupling agent having an amino group, a hydrolyzable group, and a linear alkyl group positioned between the amino group and the hydrolyzable group. In addition, the organic film-coated soft magnetic powder 1 has the average particle diameter of 1.0 μm or more and less than 10.0 μm on a volume basis measured by a laser diffraction particle size distribution measuring device. Further, when the minimum coating area [m²/g] of the coupling agent is CS and the specific surface area [m²/g] of the oxide film-coated soft magnetic powder 2 is Sm, the actual addition amount [mass %] of the coupling agent, calculated from the content [mass %] of the compound, is 0.5 times or more and less than 2.0 times of the theoretical addition amount CA [mass %] of the coupling agent calculated by the following formula.

$$CA = Sm / CS \times 100$$

According to such a configuration, the organic film-coated soft magnetic powder 1 capable of producing a green compact with excellent fillability and compatibility with a binder resin, and little variation in strength is obtained.

In the organic film-coated soft magnetic powder 1 according to the embodiment, the actual addition amount of the coupling agent is preferably 0.05 mass % or more and 0.30 mass % or less.

According to such a configuration, the actual addition amount of the coupling agent can be further optimized, and thus the occurrence of shortage or excess of the coupling agent can be suppressed.

In the organic film-coated soft magnetic powder 1 according to the embodiment, the amino group is preferably a primary amino group.

According to such a configuration, the primary amino group has excellent reactivity with, for example, an epoxy group and the like, and thus can particularly contribute to compatibility with a binder resin.

In the organic film-coated soft magnetic powder 1 according to the embodiment, the number of carbon atoms in the linear alkyl group is preferably 1 or more and 6 or less.

According to such a configuration, the compounds are easily aligned in the organic film 3 due to the interaction between the linear alkyl groups. This makes it easier to arrange amino groups on the surface. In addition, it is possible to sufficiently ensure the moisture resistance and lipophilicity while preventing the occupancy rate of the organic film 3 from increasing more than necessary.

In the organic film-coated soft magnetic powder 1 according to the embodiment, the oxide film-coated soft magnetic powder 2 may further include the insulating coating 4. The insulating coating 4 is provided on the surface of the oxide film 26 and contains ceramics or glass. In this case, the organic film 3 is provided on the surface of the insulating coating 4.

According to such a configuration, sufficient electrical insulation properties are imparted to the insulating coating 4. As a result, the iron loss caused by the eddy current between the particles can be suppressed in the green compact. Further, when the terminal is formed at the green compact, the withstand voltage between the terminals can be enhanced.

The method for producing the organic film-coated soft magnetic powder according to the embodiment includes a step of forming the organic film 3, which is provided on the surface of the oxide film-coated soft magnetic powder 2 and contains a compound derived from the coupling agent, thereby obtaining the organic film-coated soft magnetic powder 1. The oxide film-coated soft magnetic powder 2 includes the soft magnetic powder 24 and the oxide film 26. The soft magnetic powder 24 is made of a soft magnetic metal material containing Fe, Si, and B. The oxide film 26 is provided on the surface of the soft magnetic powder 24 and contains an oxide of an element contained in the soft magnetic metal material. The coupling agent has an amino group, a hydrolyzable group, and a linear alkyl group located between the amino group and the hydrolyzable group. The above step causes a hydrolysis reaction and a condensation reaction in the coupling agent in the presence of the oxide film-coated soft magnetic powder 2 and the coupling agent. In addition, the organic film-coated soft magnetic powder 1 has the average particle diameter of 1.0 μm or more and less than 10.0 μm on a volume basis measured by a laser diffraction particle size distribution measuring device. Further, when the minimum coating area [m²/g] of the coupling agent is CS and the specific surface area [m²/g] of the oxide film-coated soft magnetic powder 2 is Sm, the actual addition amount [mass %] of the coupling agent used in the step is 0.5 times or more and less than 2.0 times of the theoretical addition amount CA [mass %] of the coupling agent calculated by the following formula. CA=Sm/CS×100

According to such a configuration, the organic film-coated soft magnetic powder 1 capable of producing a green compact with excellent fillability and compatibility with a binder resin, and little variation in strength can be produced.

In the method for producing the organic film-coated soft magnetic powder according to the embodiment, the moisture content of the organic film-coated soft magnetic powder 1 is preferably 50% or more and 120% or less of the moisture content of the oxide film-coated soft magnetic powder 2.

According to such a configuration, the moisture absorption associated with the formation of the organic film 3 can be minimized. Therefore, it is possible to produce the organic film-coated soft magnetic powder 1 in which defects such as rust formation over time, aggregation associated with moisture absorption, and the like are unlikely to occur.

In the method for producing the organic film-coated soft magnetic powder according to the embodiment, the specific surface area of the organic film-coated soft magnetic powder 1 is preferably 40% or more and 120% or less of the specific surface area of the oxide film-coated soft magnetic powder 2.

According to such a configuration, the change in the specific surface area associated with the formation of the organic film 3 can be minimized.

In the method for producing the organic film-coated soft magnetic powder according to the embodiment, the oxygen content of the organic film-coated soft magnetic powder 1 is preferably 50% or more and 140% or less of the oxygen content of the oxide film-coated soft magnetic powder 2.

According to such a configuration, the variation amount with respect to the oxygen content of the oxide film-coated soft magnetic powder 2 is suppressed. Therefore, it is possible to produce the organic film-coated soft magnetic powder 1 in which a decrease in magnetic properties associated with the formation of the organic film 3 is suppressed.

The dust core according to the embodiment includes the organic film-coated soft magnetic powder 1 according to the embodiment.

According to such a configuration, a dust core with less variation in strength can be obtained.

A magnetic element according to the embodiment includes the dust core according to the embodiment.

According to such a configuration, it is possible to obtain a magnetic element in which the variation in strength of the dust core is small and the density is high.

The electronic device according to the embodiment includes the magnetic element according to the embodiment.

According to such a configuration, an electronic device that is reduced in size, increased in output, and increased in reliability can be obtained.

The organic film-coated soft magnetic powder, the method for producing the organic film-coated soft magnetic powder, the dust core, the magnetic element, and the electronic device according to the present disclosure have been described above based on the preferred embodiments, but the present disclosure is not limited thereto. For example, the organic film-coated soft magnetic powder, the dust core, the magnetic element, and the electronic device according to the present disclosure may be what is obtained by replacing each unit of the embodiment described above with any component having the same function, or what is obtained by adding any constituent to the embodiment described above. The method for producing the organic film-coated soft magnetic powder according to the present disclosure may be one in which any desired step is added to the above embodiment.

Further, in the above-mentioned embodiment, as the application example of the organic film-coated soft magnetic powder according to the present disclosure, the dust core is described, however, the application is not limited thereto, and for example, it may be applied to a magnetic device such as a magnetic a magnetic shielding sheet, and a magnetic head. In addition, shapes of the dust core and the magnetic element are not limited to those shown in the drawings, and any shapes may be adopted.

### EXAMPLES

Next, specific examples of the present disclosure will be described.

### 6. PRODUCTION OF ORGANIC FILM-COATED SOFT MAGNETIC POWDER

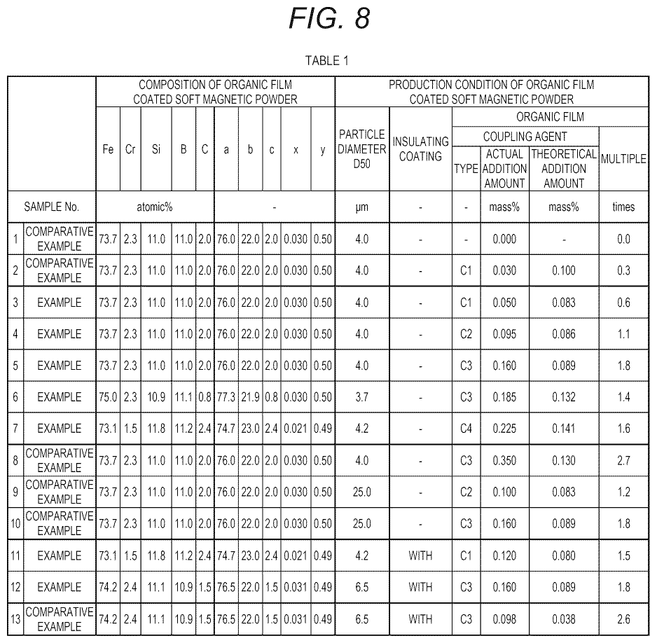

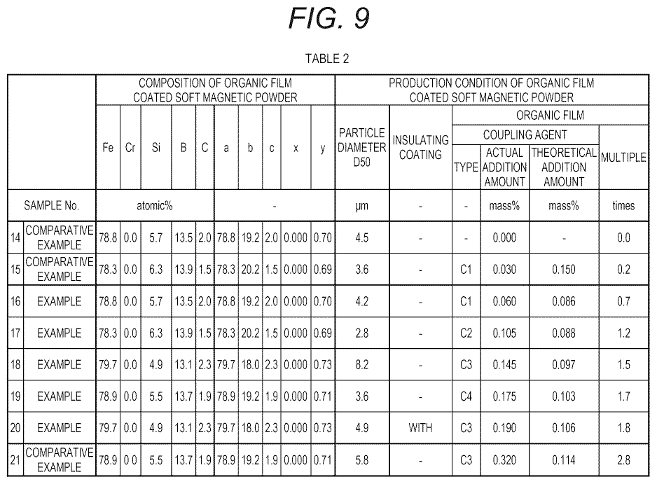

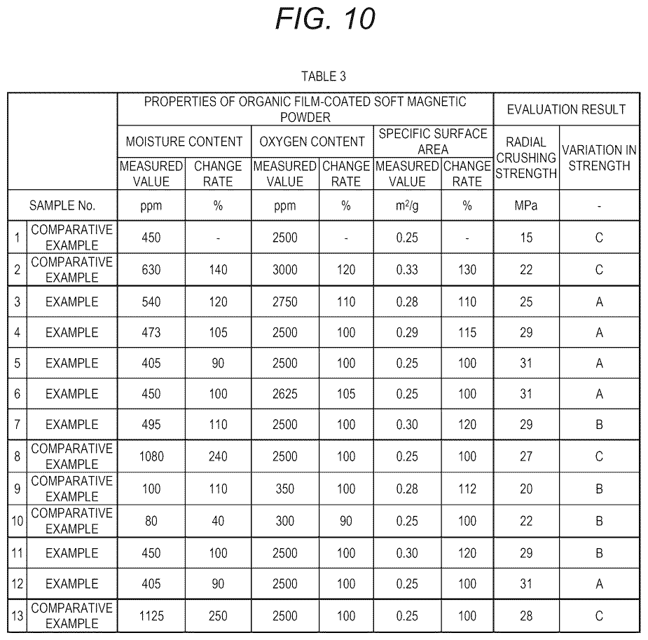

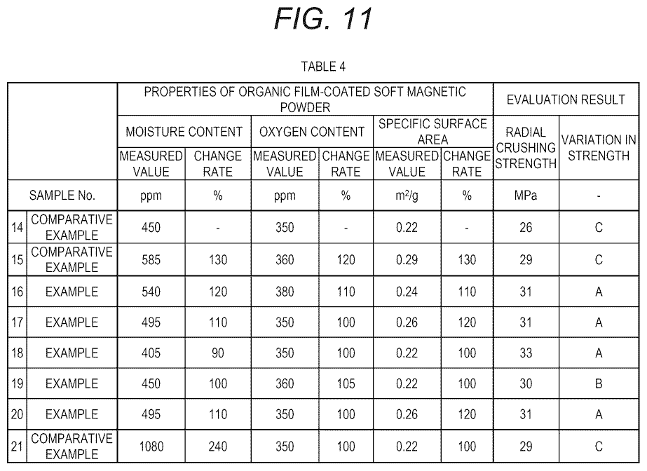

FIG. 8 is Table 1 showing the compositions and the like for the organic film-coated soft magnetic powders of sample Nos. 1 to 13. FIG. 9 is Table 2 showing the compositions and the like of the organic film-coated soft magnetic powders of sample Nos. 14 to 21. FIG. 10 is Table 3 showing the evaluation results and the like of the organic film-coated soft magnetic powders of sample Nos. 1 to 13. FIG. 11 is Table 4 showing the evaluation results and the like of the organic film-coated soft magnetic powder of Sample Nos. 14-21.

### 6.1. Sample No. 1

First, a raw material was melted in a high-frequency induction furnace and pulverized by a water atomization method to obtain the oxide film-coated soft magnetic powder containing an amorphous alloy.

Next, classification was performed by a classifier using a mesh having an opening of 53 μm, and the oxide film-coated soft magnetic powder after classification was collected. The composition of the oxide film was analyzed by X-ray photoelectron spectroscopy (XPS), revealing that silicon oxide was the main component.

Next, the collected oxide film-coated soft magnetic powder was subjected to a surface treatment using a coupling agent to form an organic film. As a result, the organic film-coated soft magnetic powder was obtained. The composition of the obtained organic film-coated soft magnetic powder is shown in Table 1. The composition was determined using a solid-state optical emission spectrometer manufactured by SPECTRO, model: SPECTROLAB, type: LAVMB08A.

### 6.2. Sample Nos. 2 to 21

The organic film-coated soft magnetic powder was obtained in the same manner as in the case of Sample No. 1 except that the composition of the organic film-coated soft magnetic powder and the production conditions of the organic film-coated soft magnetic powder were changed as shown in Table 1 or 2.

In the production of the organic film-coated soft magnetic powder of Sample No. 9 to 10, a rotary water atomization method was used.

A phosphate film formed glass by a mechanochemical method was used as an insulating coating.

In addition, regarding the produced organic film-coated soft magnetic powder, the particle diameter D50, the presence or absence of the insulating coating, the type of the coupling agent, the actual addition amount and the theoretical addition amount of the coupling agent, and the multiple of the actual addition amount with respect to the theoretical addition amount are shown in Tables 1 and 2, respectively. The types of the coupling agents shown in Tables 1 and 2 are as follows.
C1: 3-Aminopropyltriethoxysilane (manufactured by Shin-Etsu Chemical Co., Ltd., KBE-903)

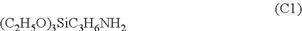

C2: N-2-(aminoethyl)-3-aminopropyltrimethoxysilane (manufactured by Shin-Etsu Chemical Co., Ltd., KBM-603)

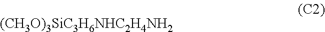

C3: 3-Aminopropyltrimethoxysilane (manufactured by Shin-Etsu Chemical Co., Ltd., KBM-903)

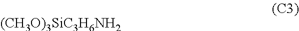

C4: N-phenyl-3-aminopropyltrimethoxysilane (manufactured by Shin-Etsu Chemical Co., Ltd., KBM-573)

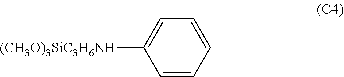

In Tables 1 to 4, among the organic film-coated soft magnetic powders of the respective sample numbers, those corresponding to the present disclosure are classified as “Example,” and those not corresponding to the present disclosure are classified as “Comparative Example”.

### 7. PROPERTIES OF ORGANIC FILM-COATED SOFT MAGNETIC POWDER

### 7.1. Moisture Content

The moisture content of the organic film-coated soft magnetic powder of each of Examples and Comparative Examples was measured by the method described above. In addition, the ratio of the moisture content of the organic film-coated soft magnetic powder to the moisture content of the oxide film-coated soft magnetic powder was calculated as a “change rate (%)”. The calculation results are shown in Tables 3 and 4.

### 7.2. Oxygen Content

The oxygen content of the organic film-coated soft magnetic powder of each of Examples and Comparative Examples was measured by the method described above. In addition, the ratio of the oxygen content of the organic film-coated soft magnetic powder to the oxygen content of the oxide film-coated soft magnetic powder was calculated as a “change rate (%)”. The calculation results are shown in Tables 3 and 4.

### 7.3. Specific Surface Area

The specific surface area of the organic film-coated soft magnetic powder of each of Examples and Comparative Examples was measured by the method described above. In addition, the ratio of the specific surface area of the organic film-coated soft magnetic powder to the specific surface area of the oxide film-coated soft magnetic powder was calculated as a “change rate (%)”. The calculation results are shown in Tables 3 and 4.

### 8. EVALUATION OF ORGANIC FILM-COATED SOFT MAGNETIC POWDER

### 8.1. Radial Crushing Strength

Molded bodies for measuring the radial crushing strength were prepared with respect to the organic film-coated soft magnetic powders of each of the Examples and Comparative Examples, and their radial crushing strength was measured by the method described above. The measurement results are shown in Tables 3 and 4.

### 8.2. Variation in Intensity

Ten molded bodies for measuring the radial crushing strength were prepared with respect to the organic film-coated soft magnetic powders of each of the Examples and Comparative Examples by the method described above. Next, the measured values of the radial crushing strength were evaluated for variations in strength in light of the following evaluation criteria. Evaluation results are shown in Tables 3 and 4.
A: The range of radial crushing strength (the difference between the maximum value and the minimum value) is less than 1 MPa.
B: The range of radial crushing strength (difference between the maximum value and the minimum value) is 1 MPa or more and less than 3 MPa.
C: The range of radial crushing strength (the difference between the maximum value and the minimum value) is 3 MPa or more.

### 8.3. Comprehensive Evaluation

As is clear from Tables 3 and 4, it was found that by using the organic film-coated soft magnetic powder of each Example, a molded body having high radial crushing strength and small variation in strength can be prepared. Such an effect is considered to be due to the organic film-coated soft magnetic powder having high fillability and high compatibility with a binder resin.

What is claimed is:

1. An organic film-coated soft magnetic powder comprising:
an oxide film-coated soft magnetic powder including a soft magnetic powder made of a soft magnetic metal material containing Fe, Si, and B, and an oxide film provided on the surface of the soft magnetic powder and containing an oxide of an element contained in the soft magnetic metal material; and
an organic film provided on the surface of the oxide film-coated soft magnetic powder and containing a compound derived from a coupling agent having an amino group, a hydrolyzable group, and a linear alkyl group located between the amino group and the hydrolyzable group;
wherein the average particle diameter on a volume basis measured by a laser diffraction particle size distribution measuring device is 1.0 μm or more and less than 10.0 μm; and
when the minimum coating area [m²/g] of the coupling agent is CS and the specific surface area [m²/g] of the oxide film-coated soft magnetic powder is Sm, the actual addition amount [mass %] of the coupling agent, calculated from the content [mass %] of the compound, is 0.5 times or more and less than 2.0 times of the theoretical addition amount CA [mass %] of the coupling agent calculated by the following formula.
$$CA = Sm / CS \times 100$$

2. The organic film-coated soft magnetic powder according to claim 1, wherein the actual addition amount of the coupling agent is 0.05 mass % or more and 0.30 mass % or less.

3. The organic film-coated soft magnetic powder according to claim 1, wherein the amino group is a primary amino group.

4. The organic film-coated soft magnetic powder according to claim 1, wherein the number of carbon atoms in the linear alkyl group is 1 or more and 6 or less.

5. The organic film-coated soft magnetic powder according to claim 1,
wherein the oxide film-coated soft magnetic powder further comprises an insulating coating provided on the surface of the oxide film and containing ceramic or glass, and
the organic film is provided on the surface of the insulating coating.

6. A method for producing the organic film-coated soft magnetic powder comprising:
causing a hydrolysis reaction and a condensation reaction of a coupling agent in the presence of an oxide film-coated soft magnetic powder, the oxide film-coated soft magnetic powder including a soft magnetic powder made of a soft magnetic metal material containing Fe, Si, and B and an oxide film provided on the surface of the soft magnetic powder and containing an oxide of an element contained in the soft magnetic metal material, and a coupling agent having an amino group, a hydrolyzable group, and a linear alkyl group located between the amino group and the hydrolyzable group, to form an organic film provided on the surface of the oxide film-coated soft magnetic powder, the organic film containing a compound derived from the coupling agent, thereby obtaining the organic film-coated soft magnetic powder;
wherein the average particle diameter on a volume basis measured by a laser diffraction particle size distribution measuring device is 1.0 μm or more and less than 10.0 μm; and
when the minimum coating area [m²/g] of the coupling agent is CS and the specific surface area [m²/g] of the oxide film-coated soft magnetic powder is Sm, the actual addition amount [mass %] of the coupling agent used in the steps is 0.5 times or more and less than 2.0 times of the theoretical addition amount CA [mass %] of the coupling agent calculated by the following formula.
$$CA = Sm / CS \times 100$$

7. The method for producing the organic film-coated soft magnetic powder according to claim 6, wherein the moisture content of the organic film-coated soft magnetic powder is 50% or more and 120% or less of the moisture content of the oxide film-coated soft magnetic powder.

8. The method for producing the organic film-coated soft magnetic powder according to claim 6, wherein the specific surface area of the organic film-coated soft magnetic powder is 40% or more and 120% or less of the specific surface area of the oxide film-coated soft magnetic powder.

9. The method for producing the organic film-coated soft magnetic powder according to claim 6, wherein the oxygen content of the organic film-coated soft magnetic powder is 50% or more and 140% or less of the oxygen content of the oxide film-coated soft magnetic powder.

10. A dust core comprising the organic film-coated soft magnetic powder according to claim 1.

11. A magnetic element comprising the dust core according to claim 10.

12. An electronic device comprising the magnetic element according to claim 11.
